(19) United States
(12) Patent Application Publication
(10) Pub. No.: US 2013/0049947 A1
(43) Pub. Date: Feb. 28, 2013

(54) SYSTEM AND METHOD FOR RETRIEVING A STATUS OF A CHILD SEAT AND SUPPLYING ENERGY THERETO

(71) Applicant: JOSHUA LANTER, (US)

(72) Inventor: JOSHUA LANTER, (US)

(73) Assignee: Polycontact AG, Chur (CH)

(21) Appl. No.: 13/569,466

(22) Filed: Aug. 8, 2012

(30) Foreign Application Priority Data
Aug. 22, 2011 (DE) 10 2011 111 266.2

(51) Int. Cl. B60Q 1/00; A47C 7/62

(52) U.S. Cl. 340/457.1; 297/217.3

(57) ABSTRACT

An exemplary system and method of monitoring a child seat in a vehicle having a seat electronics arrangement which is structured to be provided at or near the child seat and a transmission arrangement structured to be provided at or near a belt of the vehicle. The transmission arrangement is configured to transmit energy and a signal from a vehicle electronics arrangement of the vehicle to the seat electronic arrangement, and to transmit the signal from the seat electronics arrangement to the vehicle electronics arrangement.

### CROSS-REFERENCE TO RELATED APPLICATION(S)

This application relates to and claims priority from German Patent Application No 10 2011 111 266.2, filed on Aug. 22, 2011, the entire disclosure of which is incorporated herein by reference.

### FIELD OF THE DISCLOSURE

The present disclosure relates to generally to system and method for monitoring a child seat, and more specifically, to exemplary embodiments of the system and method for retrieving a status of child seat and supplying energy thereto.

### BACKGROUND INFORMATION

In motor vehicles today, it can be easy for a driver or passenger to accidentally leave a child in the car. People can become distracted by the radio, telephone conversations, other people in the car etc., and can forget that there is a child in the backseat. Additionally, as it is recommended for infants to be seated backwards facing for at least the first year of the infant's life, a person can not easily tell, or remember, that there is an infant in the back seat as they cannot see the infant.

It can be very dangerous to leave an infant or child in the back seat of the car. Extreme temperatures in the summer and winter can present serious problems to the infant or child, even resulting in the death of the infant or the child.

Prior art systems have attempted to overcome such problems. For example, U.S. Patent Publication No. US 2008/0119989 to Henning et al. describes a system for preventing a child from being accidentally left behind in a vehicle. Such prior system includes an electronic system and a sensor on the child seat. Depending on whether or not the engine of the vehicle is running, the sensor is checked at regular intervals to determine if a child is sitting in the child seat. If the engine is stopped or turned off, an alarm is triggered if the child is still sitting in the seat after a predetermined amount of time. The alarm can optionally send a signal to the guardian of the child. A problem with this system is that the only information provided is whether or not the child is in the seat. Additional information about the vital statistics of the child, including if the child is seated properly, etc. are not provided but can be beneficial.

Thus, it may be beneficial to provide exemplary system and method for determining if an infant or child has been left in a car and other statistics associated with the child seat which can overcome at least some of the deficiencies described herein above.

### SUMMARY OF EXEMPLARY EMBODIMENTS

One of objects of the present disclosure is to provide an exemplary system and method for providing reliable monitoring of a child seat. Thus, to achieve at least some of such objects, exemplary system and method can be provided for a reliable monitoring of a child seat. Such exemplary system and method can include a seat electronics arrangement (e.g., a system), which can be fitted to a child seat, and a transmission arrangement (e.g., a system) which can be fitted to a vehicle belt buckle or other location. The child seat can be fixed or fitted in a front seat and/or a rear seat of the vehicle. The child can be “strapped in” using the belt, assuming the child seat has a separate belt, or the child seat can be strapped in together with the child sitting on the child seat.

The phrase “can be fitted” encompasses any manner in which the seat electronics arrangement may be positioned and installed on or in the child seat. Similarly, the phrase “can be fitted” encompasses any manner in which the transmission arrangement may be positioned and integrated on or in a vehicle belt buckle.

The transmission arrangement can send a signal transmission from the seat electronics arrangement to the vehicle electronics arrangement, and also transmit an energy, or power, transmission and signal transmission from the vehicle to the seat electronics arrangement. The exemplary system and method for providing reliable monitoring of a child seat can distinguish between an energy transmission, which may take place in a constant manner and at a higher voltage level, and signal transmission, which may take place at a lower voltage level and in a generally alternating manner.

According to an exemplary embodiment of the system and method for providing reliable monitoring of a child seat, the seat electronics arrangement can comprise at least one sensor for detecting a parameter of the status of the child seat. The parameter can be or include, for example, the seat surface loading, the backrest loading, the released/engaged state of the belt buckle, the tension in the belt, the vital statistics of the child sitting on the child seat, the positioning of the child seat with respect to the vehicle and/or the fixing of the child seat to the vehicle, although not limited thereto.

According to an exemplary embodiment of the present disclosure, the exemplary system and method can monitor whether the child seat has been securely and correctly positioned on a vehicle seat and, and/or whether a child sitting on the seat is safely strapped in. The exemplary system and method can further monitor vital statistics such as the heart beat, respiration and/or temperature of a child, although not limited thereto.

The exemplary system and method can also include an energy storage arrangement which can supply energy to the seat electronics arrangement; the energy storage arrangement can be or include a battery and/or an accumulator which can be charged via the transmission means, although not limited thereto. The transmission arrangement can transmit energy and signals between the seat electronics arrangement and the vehicle electronics arrangement in a wireless and/or contact-free manner.

In order to achieve a reliable transmission of energy and signals in the exemplary system and method for providing reliable monitoring of a child seat, a send/receive unit/arrangement of the seat electronics arrangement can be arranged laterally in the lower region at the rear of the child seat in such a way that said send/receive unit is adjacent to the vehicle belt buckle on the vehicle seat and is oriented towards the transmission arrangement with respect to the transmission arrangement, which can be arranged on or in the vehicle belt buckle. Once a child seat is correctly and securely fixed to a vehicle seat, a reliable transmission of energy and signals can be achieved.

In another exemplary embodiment of the present disclosure, the exemplary system and method can further comprise at least one indicating element, which can be arranged on the vehicle belt buckle, which can set up the indicating element so as to provide an acoustic signal and/or an optical signal, thereby providing an indication as to a detected status of the child seat. For example, a red LED can indicate that at least one of the above-mentioned parameters does not fall within a pre-determined range of values, whereas a green LED can indicate that the child is sitting correctly, and thus safely in the child seat and is strapped in. The optical signal can alternatively be provided using a small display, whereby complex information can also be presented. A loudspeaker can also be used to emit an acoustic signal, which can be perceived even when the vehicle belt is not visible. The state of charge of the energy storage arrangement in the child seat can also be indicated using the indicating element.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figure showing an illustrative embodiment of the present disclosure, in which:

FIG. 1 is a schematic diagram of a system for providing reliable monitoring of a child seat according to an exemplary embodiment of the present disclosure.

Throughout the drawings, the same reference numerals and characters, unless otherwise stated, are used to denote like features, elements, components, or portions of the illustrated embodiments. Moreover, while the present disclosure will now be described in detail with reference to the figures, it is done so in connection with the illustrative embodiments and is not limited by the particular embodiments illustrated in the figures.

### DETAILED DESCRIPTION

The exemplary embodiments of the present disclosure may be further understood with reference to the following description and the related appended drawings. The exemplary embodiments of the present disclosure relate to system and method for monitoring a child seat. For example, the exemplary system and method can retrieve the status of child seat and supply energy thereto. The exemplary embodiments are described with reference to a child seat, although those having ordinary skill in the art will understand that the exemplary embodiments of the present disclosure may be implemented on any seat.

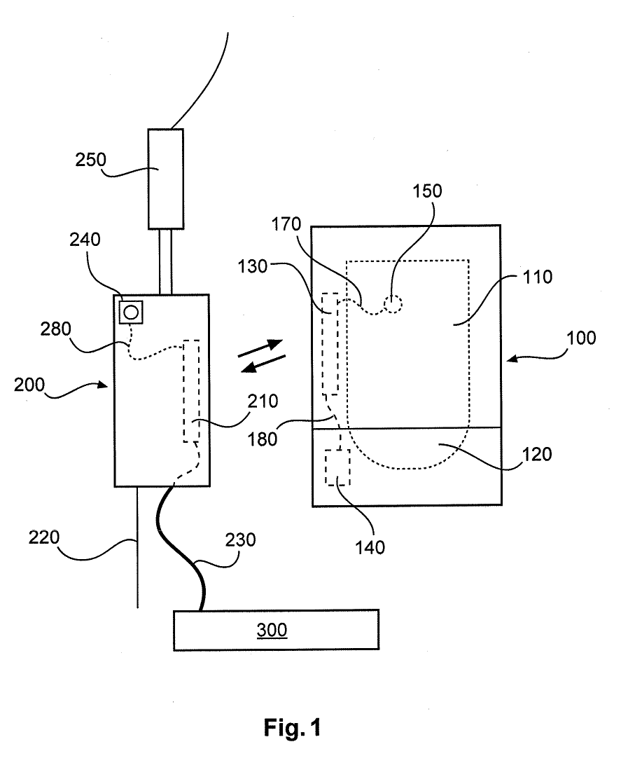

FIG. 1 shows an exemplary child seat arrangement/configuration 100 in accordance with an exemplary embodiment of the present disclosure which can include a seat surface 110 and a backrest 120. A vehicle belt buckle 200 and a vehicle electronics system 300 can be seen.

A seat electronics system/arrangement 130 and a sensor arrangement 150 are shown in FIG. 1 as being provided in the seat surface 110 of the child seat arrangement/configuration 100, and can be interconnected via an electrical conductor 170. The seat electronics system 130 can be connected via an electrical conductor arrangement 180 to an energy storage arrangement 140, such as, e.g., a battery or an accumulator.

The seat electronics system 130 can be connected to a transmission arrangement/system 210 in the vehicle belt buckle 200 which can be effectuated in a wired or a wireless/contact-free manner. The seat electronics system 130 and the transmission arrangement 210 can include, e.g., corresponding coils which can transmit energy and/or signals in an electromagnetic manner. Once the signals have been transmitted from the seat electronics system to the transmission arrangement, the signals can be relayed via an electrical conductor 230 to the vehicle electronics system 300.

A contact-free transmission between the transmission arrangement 210 and the seat electronics system 130 is symbolically represented in FIG. 1 by the arrows between the vehicle belt buckle 200 and the child seat arrangement/configuration 100. The seat electronics system 130 can be located separate and away from the region of the seat surface 110 and/or in and/or on the child seat arrangement/configuration 100.

The seat electronics system 130 which can be connected in a contact-free manner to a transmission arrangement 210 can be arranged in a region laterally below the backrest in the rear region of the child seat arrangement/configuration 100. This can help facilitate a reliable transmission of energy and signals.

In addition, the representation of the sensor arrangement 150 as being in the region of the seat surface 110 can also be arranged or provided at a different point or location on the child seat arrangement/configuration 100. For example, a plurality of sensors can be provided, which sensors can detect different parameters of the child seat arrangement/configuration 100 and/or of a child in the child seat arrangement/configuration 100.

The position of the energy storage arrangement 140 in FIG. 1 is for exemplary purposes only, as the position of the energy storage arrangement 140 can be modified or moved.

The vehicle belt buckle 200 can be located next to or near the child seat arrangement/configuration 100 and can comprise a belt buckle bracket 220 which can connect the belt buckle to the vehicle body. An electric conductor 230 can be integrated into the belt buckle bracket and can connect the transmission arrangement 210 to a vehicle electronics system. A belt tongue 250 can also be inserted from above into the vehicle belt buckle 200.

An indicating element/arrangement 240, such as, e.g., an LED, can be connected to the transmission arrangement 210 via an electrical conductor 280. The indicating element/arrangement 240 can provide a signal based on the status of the child seat arrangement/configuration 100, which can be independent of the vehicle electronics system 300.

The position of the indicating element/arrangement 240 is not limited to the position represented. Additionally, the indicating element/arrangement 240 can be or include either an optical indicating element and/or an acoustic indicating element.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances.

It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties. In the claims, the word “comprising” does not exclude other elements and the indefinite articles “a” or “an” do not exclude a plurality.

What is claimed is:

1. A device for monitoring a child seat in a vehicle, comprising:
a seat electronics arrangement which is structured to be provided at or near the child seat; and
a transmission arrangement structured to be provided at or near a belt of the vehicle, wherein the transmission arrangement is configured to transmit:
a. an energy and a signal from a vehicle electronics arrangement of the vehicle to the seat electronics arrangement, and
b. the signal from the seat electronics arrangement to the vehicle electronics arrangement.

2. The device of claim 1 wherein the seat electronics arrangement comprises a sensor for detecting a parameter of a status of the child seat.

3. The device of claim 2, wherein the parameter is at least one of a seat surface loading, a backrest loading, a released/engaged state of a buckle of the belt, a tension in the belt, a vital statistics of a child sitting on the child seat, a position of the child seat with respect to the vehicle, or a fixing status of the child seat to the vehicle.

4. The device of claim 1, wherein the seat electronics arrangement comprises an energy storage arrangement configured to supply the energy to the seat electronics arrangement.

5. The device of claim 4, wherein the energy storage arrangement is chargeable via the transmission arrangement.

6. The device of claim 1, wherein the transmission arrangement is configured to wirelessly transmit the energy and the signal.

7. The device of claim 1, further comprising an indicating arrangement.

8. The device of claim 7, wherein in the indicating arrangement is connected to a buckle of the belt.

9. The device of claim 7, wherein the indicating arrangement is at least one of an optical element or an acoustic element.

10. The device of claim 7, wherein the indicating arrangement is an LED.

11. The device of claim 1, wherein the transmission arrangement is connected to a buckle of the belt.

12. A method for indicating the status of a child seat comprising:
transmitting, using a transmission arrangement structured to be provided at or near a belt of a vehicle:
a. an energy and a signal from a vehicle electronics arrangement of the vehicle to a seat electronics arrangement, the seat electronics arrangement structured to be provided at or near the child seat;; and
b. a signal from the seat electronics arrangement to the vehicle electronics arrangement.

13. The method of claim 12, wherein the seat electronics arrangement comprises a sensor for detecting a parameter of a status of the child seat.

14. The method of claim 13, wherein parameter is at least one of a seat surface loading, a backrest loading, a released/engaged state of a belt buckle, a tension in a belt, a vital statistics of a child sitting on the child seat, a position of the child seat with respect to the vehicle, or a fixing status of the child seat to the vehicle.

15. The method of claim 12, wherein the seat electronics arrangement comprises an energy storage arrangement configured to supply energy to the seat electronics arrangement.

16. The method of claim 12, wherein the transmission arrangement is configured to wirelessly transmits the energy and the signal.

17. The method of claim 12 further comprising indicating a parameter of the status of the child seat using an indicating arrangement.

18. The method of claim 17, wherein in the indicating arrangement is connected to a vehicle belt buckle.

19. The method of claim 17, wherein the indicating arrangement is at least one of an optical element or an acoustic element.

20. The method of claim 17, wherein the indicating arrangement is an LED.
